(19) United States
(12) Patent Application Publication
(10) Pub. No.: US 2018/0027064 A1
(43) Pub. Date: Jan. 25, 2018

(54) PROGRAM AND STATISTICAL PROCESSING SYSTEM

(71) Applicant: AGOOP Corp., Tokyo (JP)

(72) Inventors: Kazuhisa SHIBAYAMA, Tokyo (JP); Yuji SOGA, Tokyo (JP); Yusuke KATO, Tokyo (JP); Hiroshi UEYAMA, Tokyo (JP)

(21) Appl. No.: 15/677,028

(22) Filed: Aug. 15, 2017

Related U.S. Application Data
(63) Continuation of application No. PCT/JP2015/054609, filed on Feb. 19, 2015.

(51) Int. Cl. H04L 29/08; H04L 12/24

(52) U.S. Cl. CPC H04L 67/1021; H04L 41/142; H04L 67/1008; G06F 3/04817

(57) ABSTRACT

A method includes: acquiring a coordinate region from a client terminal; if region information or a load on a computer or on a communication line between the computer and a client terminal satisfies a predetermined condition, performing a statistical process on a piece of sample data included in the coordinate region among a plurality of pieces of sample data in which coordinate positions and information related to the coordinate positions are associated with each other, transmitting the piece of sample data to the client terminal; and if the region information or the load on the computer or the communication line does not satisfy a predetermined condition, transmitting the piece of sample data included in the coordinate region to the client terminal.

### BACKGROUND

### 1. Technical Field

The contents of the following PCT patent application are incorporated herein by reference:
NO. PCT/JP2015/054609 filed on Feb. 19, 2015.

The present invention relates to a program and a statistical processing system.

### 2. Related Art

It has been known to prepare a cartogram by superimposing statistical data prepared by government or municipal offices or local governments with map data one on another (please see Patent Document 1, for example).

### PRIOR ART DOCUMENT

### Patent Document

(Patent Document 1) Japanese Patent Application Publication No. H7-44678

In a conventional case of statistical data prepared on a prefecture level or municipality level, variations of statistical data superimposition methods are not many, and statistical data display methods have never been well examined.

### SUMMARY

A first aspect of the present invention provides a program. A non-transitory computer-readable medium that stores a program may be provided. The above-mentioned program causes a computer to execute a procedure of acquiring, from a client terminal, region information indicating a coordinate region. The above-mentioned program causes a computer to execute a procedure of implementing a statistical process on a piece of sample data included in the coordinate region from among a plurality of pieces of sample data in which coordinate positions and information related to the coordinate positions are associated with each other, and transmitting the piece of sample data to the client terminal if at least one of: the region information; a load on the computer; and a load on a communication line between the computer and the client terminal satisfies a predetermined condition. The above-mentioned program causes a computer to execute a procedure of transmitting, to the client terminal, the piece of sample data included in the coordinate region if at least one of: the region information; the load on the computer; and the load on the communication line does not satisfy the predetermined condition.

In the above-mentioned program, the region information may include region specifying information for specifying the coordinate region on a coordinate plane expressed by a first coordinate axis and a second coordinate axis. In the above-mentioned program, the region information may include unit specifying information for specifying a range of coordinates included in a first unit region that virtually divides the coordinate plane.

In the above-mentioned program, the procedure of implementing a statistical process on the piece of sample data included in the coordinate region and transmitting the piece of sample data to the client terminal may: a procedure of extracting, for each first unit region, the piece of sample data included in the coordinate region specified by the region specifying information based on a coordinate position of each among the plurality of pieces of sample data; a procedure of associating an extracted piece of sample data with any one of one or more classes about the information related to the coordinate position based on the information related to the coordinate position of the extracted piece of sample data; and a procedure of tabulating, for each first unit region, a number of pieces of sample data corresponding to each among the one or more classes. In the above-mentioned program, the procedure of implementing a statistical process on the piece of sample data included in the coordinate region and transmitting the piece of sample data to the client terminal may have: a procedure of referring to a storing means storing a tabulated value of sample data corresponding to each among one or more classes about the information related to the coordinate position for each second unit region that virtually divides the coordinate plane, and tabulating, for each first unit region, a number of pieces of sample data corresponding to each among the one or more classes based on the tabulated value corresponding to each among the one or more classes in the second unit region included in the first unit region.

In the above-mentioned program, the unit specifying information may include information indicating a scale of a map or information indicating that the scale is to be altered. In the above-mentioned program, the coordinate position may include positional information indicating a geographic position at which the information related to the coordinate position is acquired.

A second aspect of the present invention provides a program. A non-transitory computer-readable medium that stores a program may be provided. The above-mentioned program causes a computer of a client terminal to execute a procedure of transmitting, to a server, region information indicating a coordinate region, and requesting: a piece of sample data included in the coordinate region from among a plurality of pieces of sample data in which coordinate positions and information related to the coordinate positions are associated with each other; or statistics of the piece of sample data included in the coordinate region. The above-mentioned program causes a computer of a client terminal to execute a procedure of calculating statistics of sample data corresponding to each among one or more classes about the information related to the coordinate position for each unit region that virtually divides the coordinate region on a coordinate plane expressed by a first coordinate axis and a second coordinate axis if a response to the request does not include a tabulated value but includes the piece of sample data included in the coordinate region.

The above-mentioned program may cause the computer to execute further a procedure of generating a screen on which a chart indicating statistics in each unit region is displayed at a position representative of each unit region on the coordinate plane. The above-mentioned program may cause the computer to execute further a procedure of generating a screen on which an icon or symbol corresponding to the information related to the coordinate position of each piece of sample data included in at least one unit region is displayed at a position on the coordinate plane corresponding to a coordinate position of each piece of sample data included in the at least one unit region if at least one of the region information and a user instruction satisfies a predetermined condition.

A third aspect of the present invention provides a program. A non-transitory computer-readable medium that stores a program may be provided. The above-mentioned program causes a computer to execute a procedure of associating each among a plurality of pieces of sample data in which a coordinate position on a coordinate plane expressed by a first coordinate axis and a second coordinate axis and information related to the coordinate position are associated with each other with any one of one or more classes about the information related to the coordinate position based on the information related to the coordinate position of each piece of sample data. The above-mentioned program causes a computer to execute a procedure of calculating statistics of sample data corresponding to each among one or more classes for each unit region virtually dividing the coordinate plane. The above-mentioned program causes a computer to execute a procedure of generating a screen on which a chart indicating the statistics in each unit region is displayed at a position representative of each unit region on the coordinate plane.

The above-mentioned program may cause the computer to execute further a procedure of generating a screen on which an icon or symbol corresponding to the information related to the coordinate position of each piece of sample data included in at least one unit region is displayed at a position on the coordinate plane corresponding to a coordinate position of each piece of sample data included in the at least one unit region if at least one of a range of a coordinate region displayed on a screen, a range of coordinates included in a unit region and a user instruction satisfies a predetermined condition.

A fourth aspect of the present invention provides a statistical processing system. The above-mentioned statistical processing system includes a region information acquiring unit that acquires, from a client terminal, region information indicating a coordinate region. The above-mentioned statistical processing system includes a statistical data transmitting unit that implements a statistical process on a piece of sample data included in the coordinate region from among a plurality of pieces of sample data in which coordinate positions and information related to the coordinate positions are associated with each other, and transmits the piece of sample data to the client terminal if at least one of: the region information; a load on the statistical processing system; and a load on a communication line between the statistical processing system and the client terminal satisfies a predetermined condition. The above-mentioned statistical processing system includes a sample data transmitting unit that transmits, to the client terminal, the piece of sample data included in the coordinate region if at least one of: the region information; the load on the statistical processing system; and the load on the communication line does not satisfy the predetermined condition.

The above-mentioned statistical processing system may further include a client terminal. In the above-mentioned statistical processing system, the client terminal may have a request transmitting unit that transmits, to a server, region information indicating a coordinate region, and requests: a piece of sample data included in the coordinate region from among a plurality of pieces of sample data in which coordinate positions and information related to the coordinate positions are associated with each other; or statistics of the piece of sample data included in the coordinate region. In the above-mentioned statistical processing system, the client terminal may have a statistical processing unit that calculates statistics of sample data corresponding to each among one or more classes about the information related to the coordinate position for each unit region that virtually divides the coordinate region on a coordinate plane expressed by a first coordinate axis and a second coordinate axis if a response to the request does not include the statistics of the piece of sample data included in the coordinate region but includes the piece of sample data included in the coordinate region.

The summary clause does not necessarily describe all necessary features of the embodiments of the present invention. The present invention may also be a sub-combination of the features described above.

### BRIEF DESCRIPTION OF THE DRAWINGS

FIG. 1 schematically shows one example of a communication status analyzing system 100.

FIG. 2 schematically shows one example of a communication terminal 110.

FIG. 3 schematically shows one example of a log information data table 300.

FIG. 4 schematically shows one example of a screen 400.

FIG. 5 schematically shows one example of the screen 400.

FIG. 6 schematically shows one example of a screen 600.

FIG. 7 schematically shows one example of the screen 600.

FIG. 8 schematically shows one example of a screen 800.

FIG. 9 schematically shows one example of a screen 910 and a screen 920.

FIG. 10 schematically shows one example of an information collecting server 120.

FIG. 11 schematically shows one example of a client terminal 130.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention. In the figures, identical or similar portions are provided with identical reference numbers, and the same explanations may not be repeated in some cases.

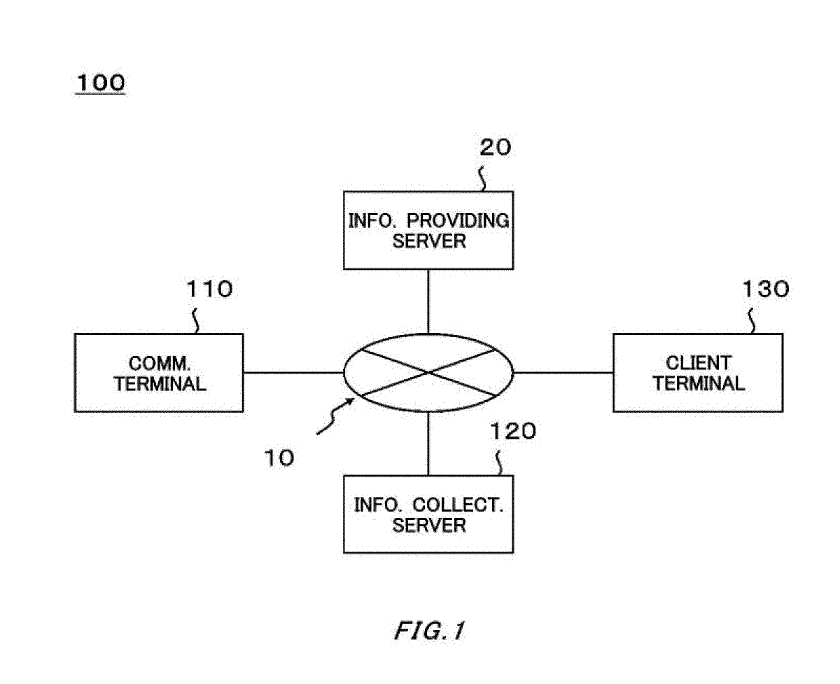

FIG. 1 schematically shows one example of a communication status analyzing system 100. In the present embodiment, the communication status analyzing system 100 includes a communication terminal 110, an information collecting server 120 and a client terminal 130. The communication status analyzing system 100 and the communication terminal 110 may be one example of an information processing device. The communication terminal 110 may be one example of a computer having a communication function. At least one of the information collecting server 120 and the client terminal 130 may be one example of a tabulating system.

In the present embodiment, the communication terminal 110 and an information providing server 20 transmit and receive information via a communication network 10. The communication terminal 110 and the information collecting server 120 transmit and receive information via the communication network 10. The information collecting server 120 and the client terminal 130 transmit and receive information via the communication network 10. The communication network 10 may be one example of a communication line between the information collecting server 120 and the client terminal 130.

The communication network 10 may be a wired communication transmission path, a wireless communication transmission path or a combination of a wireless communication transmission path and a wired communication transmission path. The communication network 10 may be a mobile communication network such as a portable phone network, a wireless packet communication network, the Internet, a dedicated line, or a combination thereof.

Each among the information providing server 20, the information collecting server 120 and the client terminal 130 may be realized by activating software or a program specifying an operation of each unit of each among the information providing server 20, the information collecting server 120 and the client terminal 130 in a generally configured information processing device. The information processing device used as at least one of the information providing server 20, the information collecting server 120 and the client terminal 130 may include: a data processing device having a processor such as a CPU, a ROM, a RAM, a communication interface and the like; an input device such as a keyboard, a touch panel or a microphone; an output device such as a display device or a speaker; and a memory device such as a memory or a HDD. The data processing device or memory device may store the above-mentioned software or program.

At least one of the information providing server 20, the information collecting server 120 and the client terminal 130 may be one example of an information processing device including: a processor; and a memory device that stores an instruction or program executed by the processor. By being executed by the processor, the above-mentioned instruction or program causes the information processing device to execute an operation specified by the instruction or program.

At least one of the information providing server 20, the information collecting server 120 and the client terminal 130 may be a virtual server or cloud system. Also, a function of at least one of the information providing server 20, the information collecting server 120 and the client terminal 130 may be realized by a plurality of servers. The client terminal 130 can be any device as long as it can transmit and receive information to and from the information collecting server 120, and may be a personal computer, a wireless terminal, a portable terminal or the like. Examples of the portable terminal may include a portable phone or smartphone, a PDA, a tablet, a notebook computer or laptop computer, a wearable computer and the like.

The information providing server 20 provides service to a user of the communication terminal 110 by providing information to the communication terminal 110 via the communication network 10. Examples of the service provided by the information providing server 20 may include information search service, on-map navigation service, mailing service, visual/music data distribution service, e-book distribution service and the like. The information providing server 20 receives, from the communication terminal 110, a transmission request about information designated by a user of the communication terminal 110. The information providing server 20 transmits the information to the communication terminal 110 in response to the transmission request from the communication terminal 110.

The communication terminal 110 has a communication function. The communication terminal 110 may have a wireless communication function. The communication terminal 110 may support a plurality of communication methods. For example, the communication terminal 110 supports both a mobile communication method such as 3G, LTE or 4G and a wireless communication method such as WiFi (registered trademark) or WiMAX (registered trademark). The communication terminal 110 can be any device as long as it can transmit and receive information to and from the information providing server 20 and the information collecting server 120, and may be a personal computer, a wireless terminal, a portable terminal or the like. Examples of the portable terminal may include a portable phone or smartphone, a PDA, a tablet, a notebook computer or laptop computer, a wearable computer and the like.

The communication terminal 110 may be realized by activate software or a program specifying an operation of each unit of the communication terminal 110 in a generally configured information processing device. An information processing device used as the communication terminal 110 may include: a data processing device having a processor such as a CPU, a ROM, a RAM, a communication interface and the like; an input device such as a keyboard, a touch panel, a microphone, a GPS information acquiring device, an acceleration sensor or a gyro sensor; an output device such as a display device, a speaker or a vibrating device; and a memory device such as a memory or a HDD. The data processing device or memory device may store the above-mentioned software or program. The communication terminal 110 may be one example of an information processing device having a communication function and including: a processor; and a memory device that store an instruction or program executed by the processor. By being executed by the processor, the above-mentioned instruction or program causes the information processing device to execute an operation specified by the instruction or program.

The communication terminal 110 accepts a user instruction, and executes a process instructed by the user instruction. The user instruction may be an instruction instructing the communication terminal 110 to execute a process other than a process for acquiring information about a communication environment. If having accepted a user instruction, the communication terminal 110 acquires information about a communication environment of the communication terminal 110 (which may be sometimes referred to as communication environment information) and positional information indicating the position at which the communication environment information is acquired. If the process instructed by the user instruction is executed, the communication terminal 110 may acquire the communication environment information and the positional information. The positional information may be information about a latitude and longitude, and may further include information about an altitude. The communication terminal 110 transmits, to the information collecting server 120, information in which at least the communication environment information and the positional information are associated with each other (which may be sometimes referred to as log information).

Examples of the communication environment information may include information about: communication possibility; radio wave status (examples of which may include radio wave reception level, radio wave intensity, RSCP (Received Signal Code Power), CID (Cell ID) and the like); communication quality (examples of which may include communication rate, throughput of data communication, latency of data communication and the like), communication method; communication carrier; and the like. The communication environment information may include information about a network other than information related to radio wave. About the communication possibility, for example, it is determined that communication is not possible (which case may be sometimes referred to as communication-impossible) if a radio wave reception level is lower than a predetermined level (for example, in case of out-of-range).

The communication possibility may be determined based on a result obtained by repeating multiple times a process of acquiring information about a particular radio wave status or communication quality (which may be sometimes referred to as an attempt). For example, if among a predetermined number of attempts, the proportion of attempts, in which the radio wave status or communication quality is better than a predetermined first threshold is larger than a predetermined second threshold, it is determined that communication is possible (communication-possible). In other cases, it is determined that communication is not possible (communication-impossible). If, in cases of “Communication-Impossible,” measurement itself is not possible as in a case where a response is not obtained within a predetermined length of time, it may be determined as a “Measurement Failure”.

The log information may be information in which communication environment information, positional information and at least one of: information indicating the time at which the communication environment information is acquired; information indicating the GPS accuracy with which the positional information is acquired; and information about the communication terminal 110 are associated with each other. Examples of the information about the communication terminal 110 may include: terminal identifying information identifying each communication terminal 110; information indicating the model of the communication terminal 110; information indicating the OS of the communication terminal 110; and the like. Examples of the information representing the GPS accuracy may include RMS (root mean square), DRMS (distance root mean square), 2DRMS, RMSE (root mean square error), CEP (circular error probability) and the like. The information representing the GPS accuracy may be the radio wave intensity of a positioning radio wave from a GPS satellite. The GPS accuracy may be one example of the positioning accuracy.

The information indicating the time at which the communication environment information is acquired may be a time at which the communication terminal 110 starts a communication environment information acquisition process, a time at which the communication terminal 110 completes a communication environment information acquisition process, or a time at which the communication terminal 110 accepts a user instruction. The terminal identifying information may be one example of identifying information that identifies a computer.

The terminal identifying information is not particularly limited as long as it is information that allows identification of each communication terminal 110, but is preferably information that allows identification of the communication terminal 110 without specifying a user. Thereby, the information collecting server 120 can analyze the log information taking into consideration temporal relevance of the log information without specifying a user.

For example, a randomly selected code string is given as terminal identifying information of a particular communication terminal 110. The code string may be a code string that is unique to each among one or more communication terminals 110, or may be re-utilized among a plurality of communication terminals 110. The terminal identifying information may be updated every time a predetermined period elapses or may be updated at any timing.

The information collecting server 120 receives log information from each among one or more communication terminals 110. The information collecting server 120 may store the received log information in a memory device. The information collecting server 120 may analyze a communication status using the log information.

In one embodiment, the information collecting server 120 implements a statistical process on the log information in response to a request from the client terminal 130, and transmits it to the client terminal 130. More specifically, the information collecting server 120 executes a statistical process on a plurality of pieces of log information. For example, the information collecting server 120 calculates statistics about one or more items included in each piece of log information (which may be sometimes referred to as parameters). The information collecting server 120 transmits the statistics obtained by implementing the statistical process to the client terminal 130. Examples of the parameters may include each piece of information included in the communication environment information, each piece of information about communication terminals 110, information indicating a GPS accuracy and the like.

The statistics may be a tabulated value of log information satisfying a particular condition about one or more parameters. The tabulated value may be a value obtained by tabulating the number of pieces of log information satisfying a particular condition, or may be a value obtained by tabulating values of tabulation target parameters of log information satisfying a particular condition.

For example, three types of information, “Communication-Possible,” “Communication-Impossible” and “Measurement-Impossible” are stored in a log information parameter “Communication Possibility.”

The information collecting server 120 refers to the parameter “Communication Possibility” of each among a plurality of pieces of tabulation target log information to calculate a tabulated value for each classification (which may be sometimes referred to as class) corresponding to details of information stored in the parameter “Communication Possibility”. For example, the information collecting server 120 tabulates the number of pieces of log information corresponding to each class.

In this case, the information collecting server 120 tabulates each among: the number of pieces of log information whose parameter “Communication Possibility” is “Communication-Possible”; the number of pieces of log information whose parameter “Communication Possibility” is “Communication-Impossible”; and the number of pieces of log information whose parameter “Communication Possibility” is “Measurement Failure”. If information is not stored in the parameter “Communication Possibility,” the log information may be processed as defective data, for example.

The information collecting server 120 may calculate a tabulated value about each among of two or more parameters. For example, the information collecting server 120 refers to parameters “OS of Communication Terminal” and “Communication Possibility” of each among a plurality of pieces of tabulation target log information to tabulate the number of pieces of corresponding log information for each class in the parameter “OS of Communication Terminal.”

Also, it tabulates the number of pieces of corresponding log information for each class in the parameter “Communication Possibility.”

The information collecting server 120 may calculate a tabulated value about a combination of two or more parameters. For example, the information collecting server 120 may refer to the parameters “OS of Communication Terminal” and “Communication Possibility” of each among a plurality of pieces of tabulation target log information to calculate a tabulated value for each class in the parameter “Communication Possibility” for each class in the parameter “OS of Communication Terminal.”

In one embodiment, the information collecting server 120 receives, from the client terminal 130, a tabulation request signal requesting to tabulate log information acquired in a particular area (which may be sometimes referred to as log information included in a particular area). The tabulation request signal may include information for specifying a tabulation target area. The information collecting server 120 may decide whether or not to execute a tabulation process at the information collecting server 120 according to whether or not at least one of information included in the tabulation request signal, the load on the information collecting server 120 and the load on the communication network 10 satisfies a predetermined condition.

If having executed a tabulation process, the information collecting server 120 may transmit, as a response to the tabulation request, a result of the tabulation process to the client terminal 130. In this case, the information collecting server 120 may transmit part of or entire log information included in a tabulation target area to the client terminal 130 together with a result of the tabulation process (which may be sometimes referred to as a tabulation result). The information collecting server 120 may sequentially transmit log information after transmitting the tabulation result. On the one hand, if not having executed a tabulation process, the information collecting server 120 may transmit part of or entire log information included in a tabulation target area to the client terminal 130 as a response to the tabulation request.

[I. Process in Case where Predetermined Condition is Satisfied]

If at least one of the information included in the tabulation request signal, the load on the information collecting server 120 and the load on the communication network 10 satisfies a predetermined condition, the information collecting server 120 tabulates log information included in a particular area indicated by the tabulation request signal among a plurality of pieces of log information. For each one or more grid squares virtually dividing a region on a map, the information collecting server 120 may tabulate log information included in the grid squares.

For example, for at least one of one or more classes about a parameter other than positional information among one or more parameters of log information included in a particular area, the information collecting server 120 calculates a tabulated value of log information corresponding to the classes. The information collecting server 120 may calculate a tabulated value of log information corresponding to each class about the above-mentioned parameter. For each one or more grid squares virtually dividing a region on a map, the information collecting server 120 may calculate a tabulated value of log information corresponding to the above-mentioned each class.

If information stored in a parameter is qualitative data like a parameter such as “Communication Possibility,” “Radio Wave Intensity” or “Radio Wave Level,” each among one or more classes about the parameter may be a class of the qualitative data itself, or may be one or more grades defined based on details of the qualitative data. For example, three types of information, “Strong,” “Normal” and “Weak,” are stored in the parameter “Radio Wave Intensity”. Also, discrete values such as “1,” “2” or “3” is stored in the parameter “Radio Wave Level”.

If information stored in a parameter is quantitative data like a parameter such as “Communication Rate,” “Data Communication Throughput” or “Data Communication Latency,” one or more classes about the parameter may be one or more grades defined based on values of the quantitative data. If information stored in a parameter is non-numeric data like a parameter such as “Communication Method” or “Communication Carrier,” one or more classes about the parameter may be details of the non-numeric data, or may be one or more grades defined based on the details of the non-numeric data.

[II. Process in Case where Predetermined Condition is not Satisfied]

On the one hand, if at least one of the information included in the tabulation request signal, the load on the information collecting server 120 and the load on the communication network 10 does not satisfy a predetermined condition, the information collecting server 120 does not execute a tabulation process on log information included in a particular area indicated by a tabulation request signal. In this case, the information collecting server 120 may extract, from each piece of log information, positional information and a tabulation target parameter to transmit them to the client terminal 130. Thereby, the amount of information to be transmitted can be reduced.

According to the present embodiment, for example, if the number of pieces of log information corresponding to a request from the client terminal 130 is relatively large, a tabulation result is transmitted, and if the number of pieces of log information is relatively small, the log information is transmitted. The thereby, the load on the communication network 10, the information collecting server 120 and the client terminal 130 can be mitigated. Also, because log information is transmitted to the client terminal 130, the log information can be processed at the client terminal 130. As a result of this, for example, a tabulation result can be displayed without being influenced by the communication rate of the communication network 10 or the like. Also, user experience can be enhanced by utilizing an animation process or the like.

In the above-mentioned embodiment, each among a plurality of pieces of log information may be one example of sample data. Positional information and a tabulation target parameter extracted from each piece of log information may be one example of sample data. Log information included in a particular area indicated by a tabulation request signal may be one example of a piece of sample data included in a coordinate region. Tabulation of log information may be one example of a statistical process. A tabulated value of log information may be one example of statistics. A tabulation request signal may be one example of region information. Information for specifying a tabulation process target area may be one example of region information.

A map is a plane defined by a first coordinate axis indicating latitude and a second coordinate axis indicating longitude, and may be one example of a coordinate plane. A region on a grid or surrounded by a grid may be one example of a unit region. A tabulation process target particular area may be one example of a coordinate region. As described above, positional information included in log information indicates a geographic position where information such as communication environment information is acquired. Positional information included in log information may be one example of a coordinate position. Information other than positional information included in log information may be one example of information related to a coordinate position. Example of the information related to a coordinate position may include: each among one or more parameters included in communication environment information; each among one or more parameters included in information about the communication terminal 110; information indicating the GPS accuracy with which positional information is acquired; and the like.

In the present embodiment, the client terminal 130 outputs a log information tabulation result. For example, the client terminal 130 transmits, to the information collecting server 120, a tabulation request signal requesting to tabulate log information in a particular area. The tabulation request signal includes information indicating a tabulation process target particular area. Among a plurality of pieces of log information, the tabulation request signal requests, from the information collecting server 120, log information acquired in the above-mentioned particular area (or part thereof) or a tabulated value of the log information. The client terminal 130 outputs a log information tabulation result based on a response from the information collecting server 120.

For example, if in a response to a tabulation request signal, a log information tabulation result is not included, but log information included in the above-mentioned particular area (or part of the log information) is included, the client terminal 130 may tabulate the log information for each one or more grid squares virtually dividing a region on a map. For example, for each among one or more classes about a parameter other than positional information among one or more parameters included in log information included in a response to a tabulation request signal, the client terminal 130 calculates a tabulated value of log information corresponding to each class.

In the present embodiment, the client terminal 130 outputs a log information tabulation result with map information being superimposed therewith. For example, the client terminal 130 generates a screen on which a chart indicating a tabulation result in each grid square is displayed at a position representative of each grid square on a map. Instead of at least one of the above-mentioned charts, the client terminal 130 may generate a screen on which an icon or symbol indicating each among a plurality of pieces of log information, which is a source of the chart, is displayed. The client terminal 130 may switch whether to display a chart or display log information, which is a source of the chart, in response to an instruction from a user or the like. The client terminal 130 may alter the type of chart in response to an instruction from a user or the like.

In the present embodiment, a case in which a coordinate position is information indicating a geographic position, and a coordinate region is information indicating a geographic range is explained. However, the coordinate position can be any information as long as it indicates a position of a point indicated by a particular coordinate in any coordinate system, and is not limited to information indicating a position of a geographic point or a point on a map. Similarly, the coordinate region can be any region in any coordinate system, and is not limited to a geographic region or a region on a map.

For example, as another embodiment, a case where each among one or more pieces of sample data is data in which information about the gender, age, annual income and marital status of an individual are associated is considered. The marital status is, for example, qualitative value data indicating married, unmarried (with marital history) or unmarried (without marital history). If for example, sample data is analyzed using an x-y plane with its x-axis indicating age and its y-axis indicating annual income, or a crosstabulation table with its horizontal axis indicating age and its vertical axis indicating annual income, the coordinate position of sample data about a particular individual A is determined by the age and annual income of the individual A. Also, the coordinate region is determined by a particular age range and annual income range. The coordinate region may be one of segments of the crosstabulation table.

In this case, for example, for each segment, the number of pieces of sample data corresponding to each among classes of marital status is tabulated. The tabulation process may be implemented for each gender, or the tabulation process may be implemented without taking gender into consideration. The tabulation result may be displayed by various types of chart at a representative position of each segment. If the tabulation process is implemented for each gender, a chart indicating a tabulation result for male and a chart indicating a tabulation result of female may be arranged at a representative position of each segment. Examples of the various types of chart may include cumulative bar chart, pie chart, doughnut chart, area chart, radar chart and the like. Thereby, a user can analyze data intuitively.

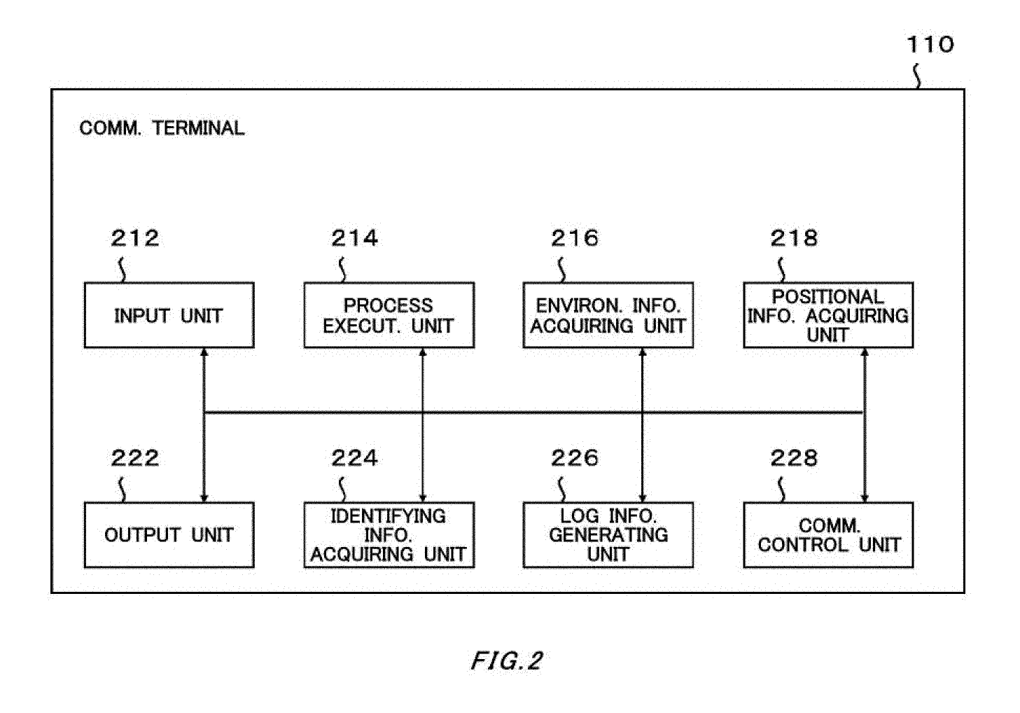

FIG. 2 schematically shows one example of the communication terminal 110. In explanation with reference to FIG. 2, explanations of matters that are the same as those in the explanation related to FIG. 1 may be sometimes omitted. In the present embodiment, the communication terminal 110 includes an input unit 212, a process executing unit 214, an environment information acquiring unit 216, a positional information acquiring unit 218, an output unit 222, an identifying information acquiring unit 224, a log information generating unit 226 and a communication control unit 228. Each unit of the communication terminal 110 transmits and receives information to and from each other.

Each unit of the communication terminal 110 may be realized by hardware, may be realized by software, or may be realized by a combination of hardware and software. Also, by a program being executed, a computer may function as part of the communication terminal 110. The program may be stored on a computer-readable medium such as a CD-ROM, a DVD-ROM, a memory or a hard disk, or may be stored on a memory device connected to a network. The program may be installed on a computer of the communication terminal 110 from a memory device connected to the computer-readable medium or the network.

The program that causes a computer to function as part of the communication terminal 110 may include a module specifying an operation of each unit of the communication terminal 110. These programs or modules act on a processor, a communication interface, a GPS information acquiring device or the like to cause the computer to function as each unit of the communication terminal 110, cause the computer to execute an information processing method in the communication terminal 110, and so on.

By being read into the computer, information processing described in these programs functions as a specific means in which software and various types of hardware resources of the communication terminal 110 cooperate with each other. Then, by realizing an arithmetic operation or process on information corresponding to the purpose of use of the computer in the present embodiment by these specific means, the communication terminal 110 corresponding to the purpose of use can be constructed.

The input unit 212 accepts a user instruction from a user. The input unit 212 may be a keyboard, a touch panel or a microphone. The user instruction instructs the communication terminal 110 to execute a process other than a process for acquiring information about a communication environment. Accordingly, the user instruction does not include an instruction that exclusively requests to acquire information for measuring a line speed or communication rate, an instruction that exclusively requests to access a server providing service of measuring a line speed or communication rate, or the like. The input unit 212 may be one example of a user request accepting unit.

The process executing unit 214 executes a process instructed by the user instruction. The process instructed by the user instruction may be a process that utilizes a communication function or may be a process that does not utilize a communication function. The type the process instructed by the user instruction may be transmitted to the log information generating unit 226.

The process instructed by the user instruction may be a process executed at the time point when the communication terminal 110 accepts the user instruction. The process instructed by the user instruction may be a process executed automatically at a predetermined time or every time a predetermined length of time elapses according to a user setting, or may be a process that is executed automatically at a predetermined time or every time a predetermined length of time elapses according to an initial setting of the communication terminal 110 or an initial setting of a program running on the communication terminal 110.

The process instructed by the user instruction may be a process of outputting information instructed by the user instruction in a form perceivable to a user. Examples of such a process may include: a process of scrolling a display screen of the communication terminal 110 to alter a display position of an image displayed on the display screen; a process of accessing the information providing server 20 to acquire, from the information providing server 20, information that is instructed by the user and display the acquired information on the display screen of the communication terminal 110; and the like.

The process instructed by the user instruction may be a process associated with pressing of a button of or switching of a switch of the communication terminal 110. The process instructed by the user instruction may be a process of turning off the power source of the communication terminal 110. The process instructed by the user instruction may be a process of logging off the communication terminal 110 or may be a process of bringing the communication terminal 110 into a sleep state.

If having accepted a user instruction, besides a process instructed by the user instruction, the environment information acquiring unit 216 acquires communication environment information of the communication terminal 110. If the process executing unit 214 executes a process instructed by a user instruction, the environment information acquiring unit 216 may acquire communication environment information besides a process instructed by the user instruction. At a predetermined time or every time a predetermined length of time elapses (which timing may be sometimes referred to as communication environment information-acquiring timing), the environment information acquiring unit 216 may acquire communication environment information.

According to one embodiment, if the input unit 212 accepts a user instruction instructing activation of a GPS logger, the environment information acquiring unit 216 acquires communication environment information every time the GPS logger acquires log information at constant time intervals. According to another embodiment, if the input unit 212 accepts a user instruction instructing activation of mailing software, the environment information acquiring unit 216 acquires communication environment information every time the mailing software accesses a mailing server in the background. According to a still another embodiment, if the input unit 212 accepts a user instruction instructing setting of an alarm function, the environment information acquiring unit 216 acquires communication environment information at the time of the setting of the alarm function or at the time of activation of the alarm function.

The environment information acquiring unit 216 may acquire communication environment information based on a length of time after the information providing server 20 is requested to transmit information that a user instructed to send until the information is acquired from the information providing server 20 and on the information amount of the information. The process of acquiring the communication environment information may be executed in the background.

Thereby, the communication environment information can be acquired while the user is manipulating the communication terminal 110. Also, even if the communication terminal 110 is executing a process that does not utilize a communication function, the communication environment information can be acquired. Furthermore, even if the user does not implement a special manipulation for acquiring the communication environment information, the communication environment information can be acquired. As a result of this, the communication status close to the actual status of use of the user can be grasped over a large area. Also, temporal changes in the communication status or the like can be grasped.

If having accepted a user instruction, besides a process instructed by the user instruction, the positional information acquiring unit 218 acquires positional information of the communication terminal 110. If the process executing unit 214 executes a process instructed by a user instruction, the positional information acquiring unit 218 may acquire positional information besides a process instructed by the user instruction. The positional information acquiring unit 218 may acquire positional information if the environment information acquiring unit 216 acquires communication environment information.

Thereby, the communication environment information can be associated with the positional information. The process of acquiring the positional information may be executed in the background.

The positional information acquiring unit 218 may acquire the positional information based on at least one of information of GPS information and radio wave information from an access point of a wireless communication network or mobile communication network. The positional information acquiring unit 218 may be a GPS information acquiring device or may acquire positional information from a GPS information acquiring device disposed in the communication terminal 110. The positional information acquiring unit 218 may acquire information about GPS accuracy together with the positional information.

The output unit 222 outputs information instructed by a user instruction in a form perceivable to a user. The output unit 222 may be a display device such as a liquid crystal display or an organic EL display, an audio output device such as a speaker or a vibrating device such as a vibrator.

For example, in response to an instruction from a user, the output unit 222 displays an image on a screen, alters a display position of an image displayed on a screen, and so on. The output unit 222 may display an image based on information acquired from the information providing server 20 via the communication network 10 or information stored in a memory device of the communication terminal 110. Also, the output unit 222 may output, as audio information and from a speaker, information acquired from the information providing server 20 via the communication network 10 or information store in a memory unit of the communication terminal 110. Thereby, the user can perceive information.

On the one hand, if a particular process is executed in the background, information utilized in the process is not output from the output unit 222 in a form perceivable to a user. For this reason, the user cannot perceive the information.

The identifying information acquiring unit 224 acquires terminal identifying information identifying each communication terminal 110. The identifying information acquiring unit 224 may generate terminal identifying information corresponding to each communication terminal 110 or may receive terminal identifying information from the information collecting server 120. The terminal identifying information may be determined randomly using random numbers, for example. The terminal identifying information may be updated at a predetermined time or every time a predetermined length of time elapses. The identifying information acquiring unit 224 may acquire information about a communication terminal 110 such as information indicating the model of the communication terminal 110 or information indicating the OS of the communication terminal 110.

The log information generating unit 226 may acquire, from the process executing unit 214, information about the type of a process instructed by a user instruction. The log information generating unit 226 may acquire communication environment information from the environment information acquiring unit 216. The log information generating unit 226 may acquire, from the environment information acquiring unit 216, information indicating the time at which communication environment information is acquired. The log information generating unit 226 may acquire, from the positional information acquiring unit 218, positional information indicating the position where communication environment information is acquired. The log information generating unit 226 may acquire, from the positional information acquiring unit 218, information about the GPS accuracy with which positional information is acquired. The log information generating unit 226 may acquire terminal identifying information from the identifying information acquiring unit 224.

The log information generating unit 226 generates log information. The log information generating unit 226 generates log information, associating at least communication environment information and positional information with each other. The log information generating unit 226 may generate log information, associating, with each other, communication environment information, positional information and at least one of: information indicating the time at which the communication environment information is acquired; information indicating the GPS accuracy with which the positional information is acquired; information about the communication terminal 110; and information about the type of a process instructed by a user instruction. The process of generating log information may be executed in the background.

The log information generating unit 226 may decide a communication method that is being used when communication environment information is acquired, based on information about latency of data communication included in the communication environment information. For example, if the latency is shorter than a predetermined value, the log information generating unit 226 determines that communication environment information acquired by the environment information acquiring unit 216 is information in a case where the communication terminal 110 is communicating by a first communication method (examples of which may include LTE, 4G and the like). On the one hand, if the latency is longer than a predetermined value, the log information generating unit 226 determines that communication environment information acquired by the environment information acquiring unit 216 is information in a case where the communication terminal 110 is communicating by a second communication method (examples of which may include 3G and the like). The log information generating unit 226 may generate log information, associating, with each other, information about a communication method being used when communication environment information is acquired, and the communication environment information and positional information.

The log information generating unit 226 may acquire an inner function of the OS running on the communication terminal 110. The log information generating unit 226 may decide a communication method having been used when communication environment information is acquired, based on the acquired inner function.

The log information generating unit 226 may generate log information every time the input unit 212 accepts a user instruction. The log information generating unit 226 may generate log information every time a process instructed by a user instruction is executed. The log information generating unit 226 may generate log information at a predetermined time or every time a predetermined length of time elapses (which timing may be sometimes referred to as log information-generating timing). The log information-generating timing may be the same as or different from communication environment information-acquiring timing.

The log information generating unit 226 may transmit generated log information to the information collecting server 120. The log information generating unit 226 may transmit log information to the information collecting server 120 every time log information is generated. The log information generating unit 226 may transmit generated log information to the information collecting server 120 at a predetermined time or every time a predetermined length of time elapses (which timing may be sometimes referred to as log information-transmitting timing). The log information-transmitting timing may be the same as or different from log information-generating timing.

At at least one of the time of activation of the communication terminal 110, the time of recovery from a sleep state of the communication terminal 110 and the time of activation of a program for causing a computer to function as part of the communication terminal 110, the log information generating unit 226 may transmit generated log information to the information collecting server 120. The log information generating unit 226 may keep generated log information stored after transmitting the log information until transmitting next log information.

The communication control unit 228 controls communication between the communication terminal 110 and the communication network 10, the information providing server 20 and the information collecting server 120. The communication control unit 228 may be a communication interface. The communication control unit 228 may support a plurality of communication methods.

In the present embodiment, a case where the information collecting server 120 is a server different from the information providing server 20, and the communication terminal 110 transmits communication environment information to the information collecting server 120 is explained. However, the communication status analyzing system 100 is not limited to the present embodiment. According to another embodiment, the communication terminal 110 transmits communication environment information to the information providing server 20. The information providing server 20 stores, in a memory device, communication environment information received from the communication terminal 110. The information collecting server 120 analyzes a communication status based on communication environment information stored in the information providing server 20. Also, the function of each unit of the communication terminal 110 is not strictly distinguished from one another, and the function of each unit of the communication terminal 110 is not limited to the above-mentioned embodiment.

In the embodiment above, a case where the communication terminal 110 grasps a communication status close to the actual status of use of a user over a large area by acquiring communication environment information and positional information if the communication terminal 110 accepts a user instruction instructing to execute a process other than a process for acquiring information about a communication environment is explained. However, the method of grasping a communication status close to the actual status of use of a user over a large area is not limited to the above-mentioned embodiment.

In another embodiment, the communication terminal 110 may automatically acquire information about a communication environment at a predetermined time or every time a predetermined length of time elapses after an input indicating that a process is to be started is accepted from a user. Because it is not necessary for a user to implement a manipulation for acquiring communication environment information every time communication environment information is acquired, a communication status close to the actual status of use of a user over a large area can be grasped. Also, temporal changes of the communication status and the like can be grasped.

In this case, the communication terminal 110 may transmit communication environment information to the information collecting server 120 every time communication environment information is acquired. The communication terminal 110 may keep acquired communication environment information stored, and transmit the stored communication environment information to the information collecting server 120 following a predetermined condition. For example, examples of the predetermined condition may include: that the number of times of acquiring communication environment information has reached a predetermined number of times; that the information amount of stored communication environment information has reached a predetermined amount; that a predetermined time has come; that a predetermined length of time has elapsed; and the like. If not being able to implement communication at timing of transmitting communication environment information to the information collecting server 120, the communication terminal 110 may keep the acquired communication environment information stored without transmitting it, and may transmit it at next transmission timing.

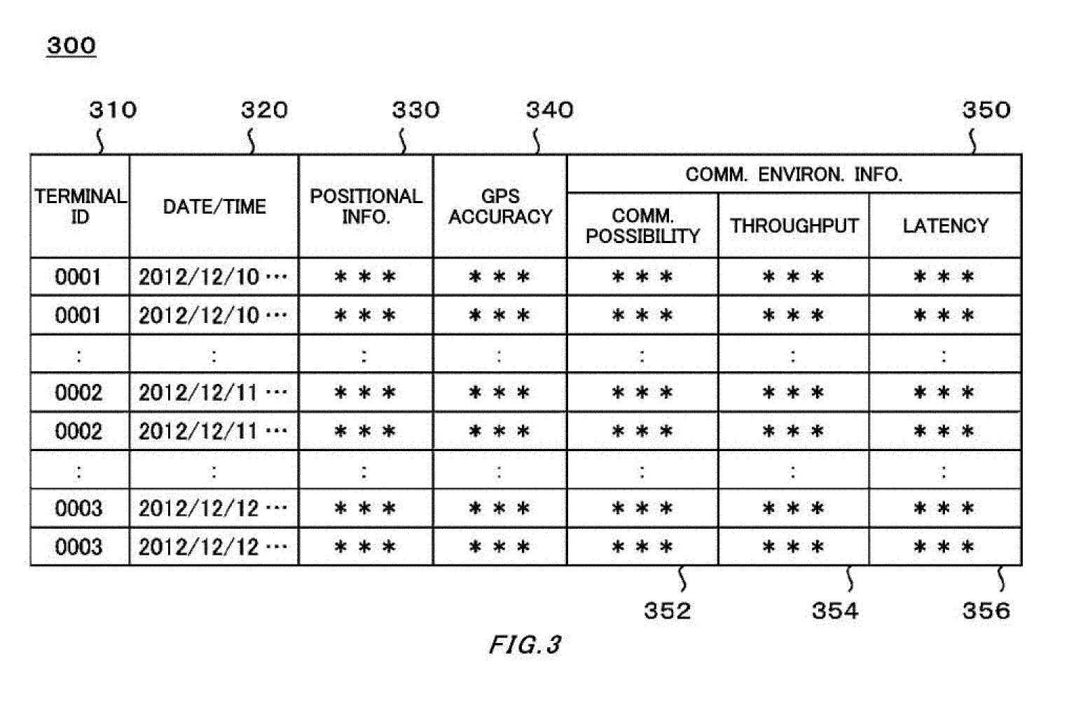

FIG. 3 schematically shows one example of a log information data table 300. The data table 300 stores, in association with each other: a terminal ID 310; information about a date and time 320 at which communication environment information is acquired; positional information 330 indicating the position where communication environment information is acquired; information about a GPS accuracy 340 with which the positional information 330 is acquired; and communication environment information 350. The communication environment information 350 may include: information about communication possibility 352; information about throughput 354 of data communication; and information about latency 356 of data communication. The terminal ID 310 may be one example of identifying information identifying a computer.

In the present embodiment, the terminal ID 310 is a randomly selected code string, and is updated every other day. Thereby, the information collecting server 120 can analyze the log information taking into consideration temporal relevance of the log information without specifying a user.

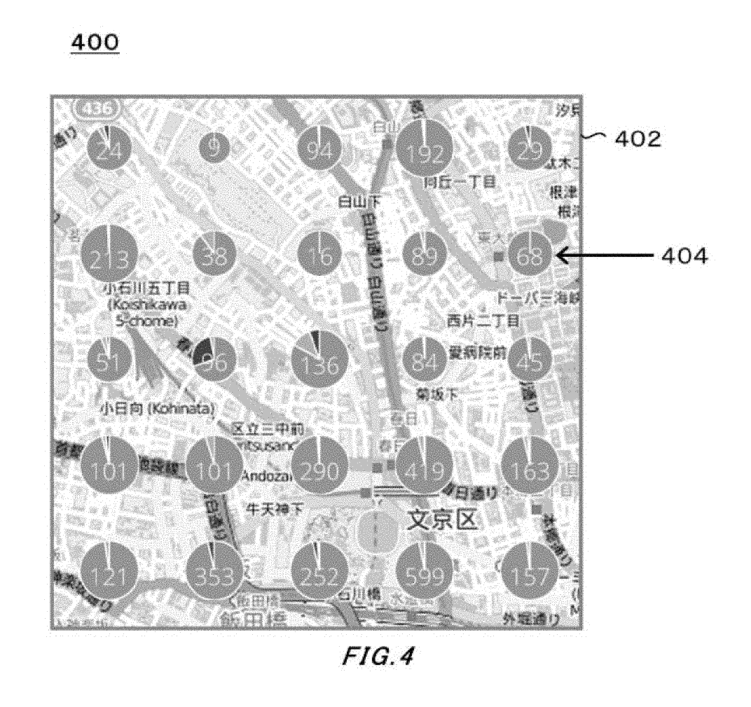

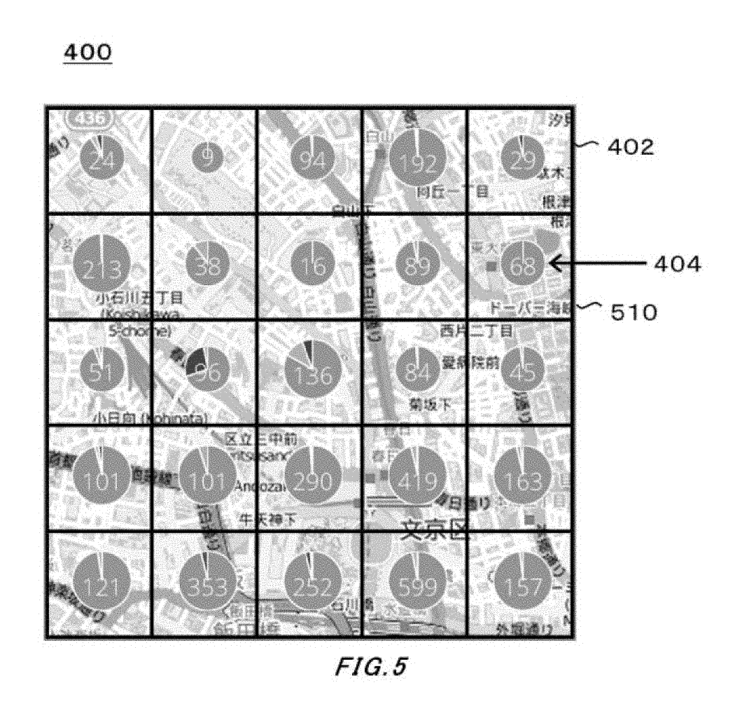

FIG. 4 schematically shows one example of a screen 400. FIG. 5 shows the screen 400 together with grid squares 510. In the present embodiment, the screen 400 is generated by the client terminal 130. In the present embodiment, the screen 400 includes a map image 402 and chart icons 404. The map image 402 includes an image indicating a map of a particular area at a particular scale. Each among a plurality of the chart icons 404 corresponds to each among a plurality of the grid squares 510 on the map, and shows a tabulation result of log information included in an area corresponding to each grid square. In the present embodiment, the scale of the map image 402 is smaller than a predetermined value, and each among the plurality of chart icons 404 is generated based on a tabulated value included in a response to a tabulation request signal.

As shown in FIG. 5, in the screen 400, the center of each among the plurality of chart icons 404 and the center of each among the plurality of grid squares 510 are disposed to coincide with each other. Thereby, a user can intuitively grasp a region to be analyzed in detail.

In the present embodiment, a case where the center of each among the plurality of chart icons 404 and the center of each among the plurality of grid squares 510 are disposed to coincide with each other is explained. However, the method of arranging the chart icons 404 is not limited to the present embodiment. In another embodiment, a point representative of each among the plurality of chart icons 404 and a point representative of each among the plurality of grid squares are disposed to coincide with each other. The chart icons 404 may be disposed on edges of grid squares.

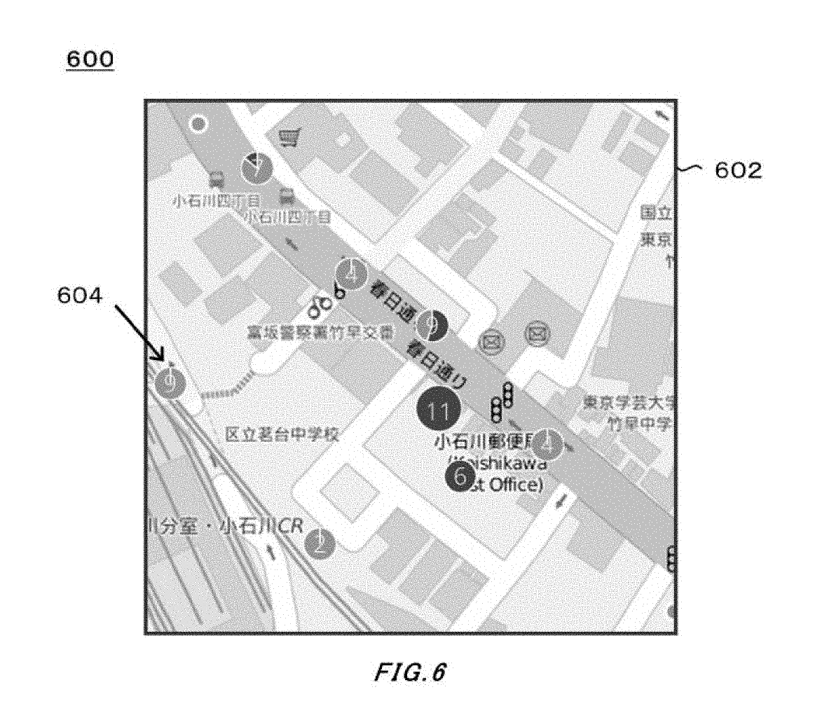

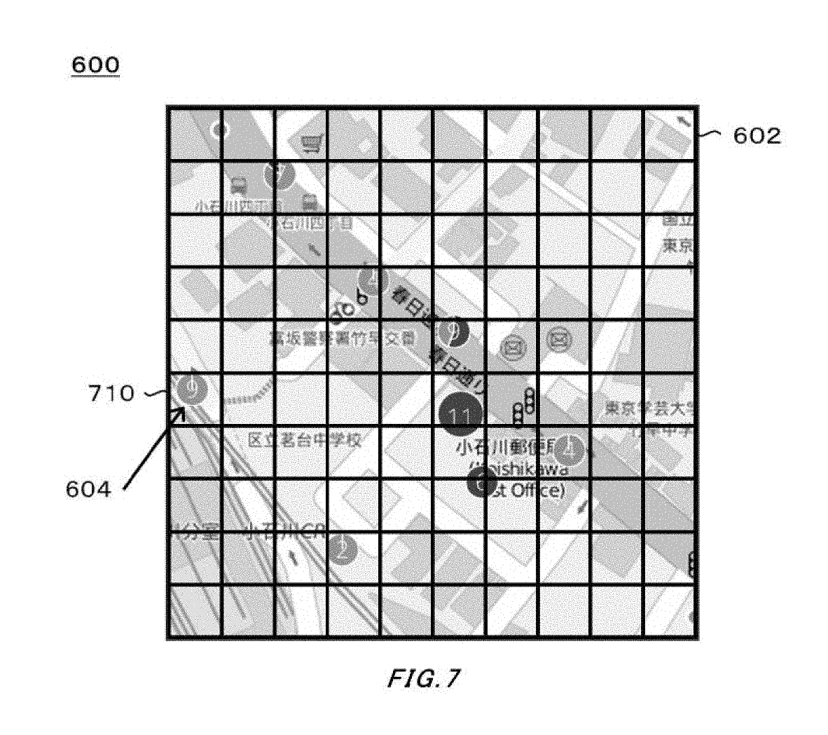

FIG. 6 schematically shows one example of a screen 600. FIG. 7 shows the screen 600 together with grid squares 710. In the present embodiment, the screen 600 is generated by the client terminal 130. In the present embodiment, the screen 600 includes a map image 602 and chart icons 604. The map image 602 is an image displaying part of the map image 402 in more detail. That is, the map image 602 is a map displaying part of a region included in the map image 402 at a scale different from that of the map image 402.

In the present embodiment, each among a plurality of the chart icons 604 corresponds to each among a plurality of the grid squares 710 on the map, and indicates a tabulation result of log information acquired in an area corresponding to each grid square. Each among the plurality of chart icons 604 is generated based on a tabulated value calculated by the client terminal 130 based on log information included in a response to a tabulation request signal.

As shown in FIG. 7, in the screen 600, the position of each among the plurality of chart icons 604 is disposed such that a point representative of each chart and the center of mass of a plurality of pieces of positional information, which are the source of each chart, coincide with each other. The arrangement of the chart icons 604 may be decided by a greedy method. Thereby, the chart icons 604 can be arranged along a road, railroad or the like on the map. Also, a user can more intuitively grasp a region to be analyzed in detail.

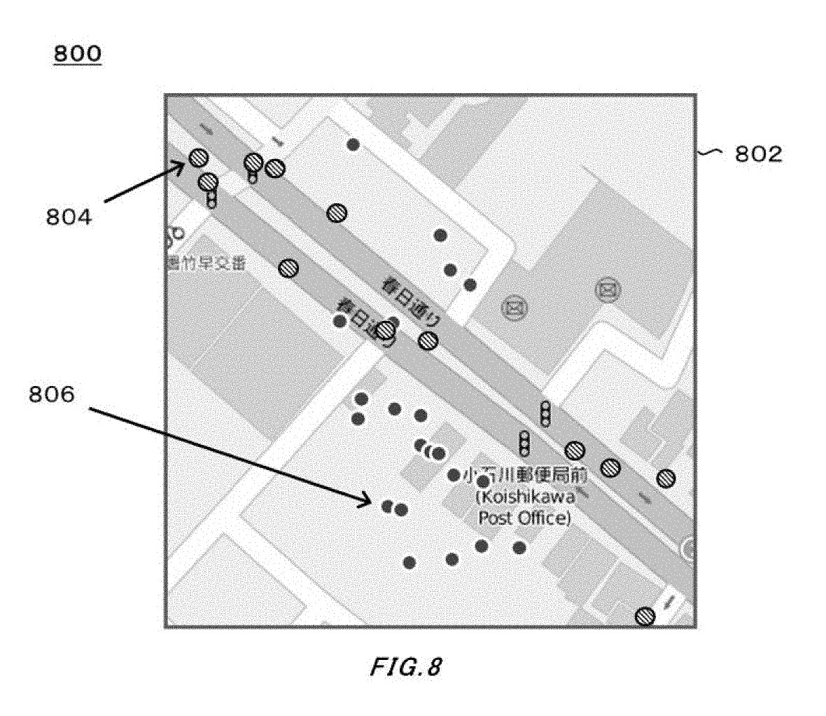

FIG. 8 schematically shows one example of a screen 800. In the present embodiment, the screen 800 is generated by the client terminal 130. In the present embodiment, the screen 800 includes a map image 802, sample icons 804 and sample icons 806. The map image 802 is an image displaying part of the map image 602 in more detail. That is, the map image 802 is a map displaying part of a region included in the map image 602 at a scale different from that of the map image 602.

Each among the plurality of sample icons 804 indicates the position of log information whose information about “Communication Possibility” included in each piece of log information indicates “Communication-Possible” among a plurality of pieces of log information acquired in an area displayed on the map image 802.

Each among the plurality of sample icons 806 indicates the position of log information whose information about “Communication Possibility” included in each piece of log information indicates “Communication-Impossible” among a plurality of pieces of log information acquired in an area displayed on the map image 802. Each among the pluralities of sample icons 804 and sample icons 806 is generated based on log information included in a response to a tabulation request signal. Thereby, a user can analyze a communication environment in an area displayed on the map image 802 in detail.

As shown in FIG. 4 to FIG. 8, according to the scale of a map, the information collecting server 120 may alter information superimposed on a map image or the method of displaying the information. According to one embodiment, the information collecting server 120 displays a tabulation result of log information included in each grid square with a chart icon if the scale of a map is smaller than a predetermined first value. Also, each among the chart icons is superimposed on a map image such that a representative point of each chart icon and a representative point of each grid square coincide with each other. According to another embodiment, the information collecting server 120 displays a tabulation result of log information included in each grid square with a chart icon if the scale of a map is smaller than a predetermined second value. Also, each among the chart icons is superimposed on a map image such that a representative point of each chart icon and the center of mass of a representative point of each grid square coincide with each other. The second value may be larger than the first value.

According to a still another embodiment, the information collecting server 120 displays log information included in each grid square with a sample icon if the scale of a map is smaller than a predetermined third value. Also, each among the sample icons is superimposed on a map image such that a representative point of each sample icon is disposed at a position indicated by the positional coordinate of log information corresponding to the sample icon. The third value may be larger than the first value and second value. The information collecting server 120 may combine these approaches to generate a display screen.

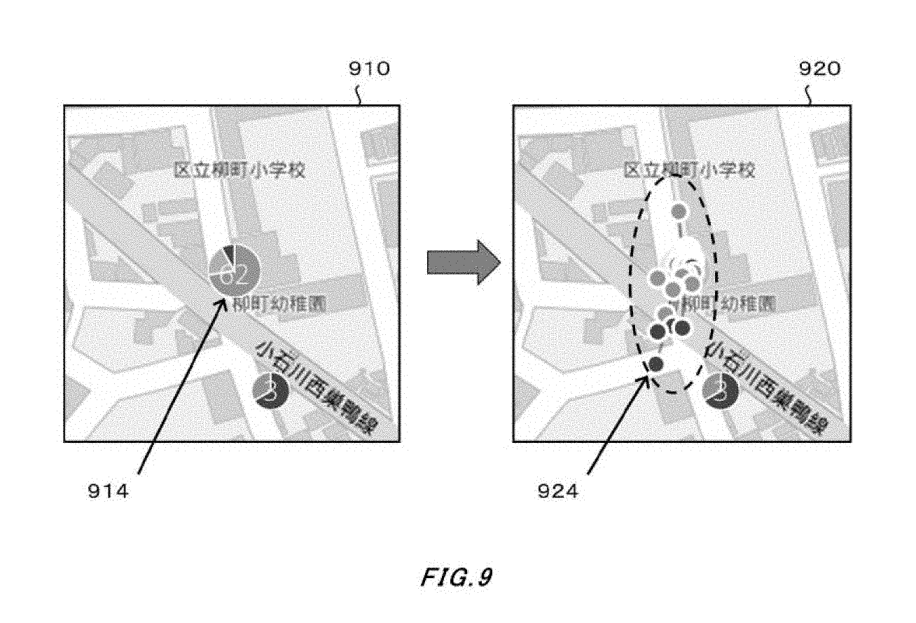

FIG. 9 schematically shows one example of a screen 910 and a screen 920. In the present embodiment, the screen 910 and the screen 920 are generated by the client terminal 130. The screen 910 includes a chart icon 914. In FIG. 9, the chart icon 914 indicates that 62 pieces of log information are included in a grid square corresponding to the chart icon 914. Also, classes of the parameter “Communication Possibility” of each piece of log information are three types, “Communication-Possible,” “Measurement Failure” and “Communication-Impossible,” and it can be known that in about 70% of log information. “Communication Possibility” is “Communication-Possible,” in about 20% of log information, “Communication Possibility” is “Measurement Failure,” and in about 10% of log information, “Communication Possibility” is “Communication-Impossible”.

In the present embodiment, the screen 920 shows a screen displayed if a user clicks the chart icon 914 on the screen 910. The above-mentioned clicking may be one example of an instruction of a user for the chart icon 914. The user instruction may be a mouse-hovering or mouse-over on the chart icon 914.

In the screen 920, a plurality of sample icons 924 are displayed in place of the chart icon 914. Each among the plurality of sample icons 924 indicates the position of each among a plurality of pieces of log information, which are the source of the chart icon 914, and the classes of the parameter “Communication Possibility”. Thereby, it is possible to switch between a display of a tabulation result by the chart icon 914 and a display of log information by the sample icon 924 by a simple manipulation.

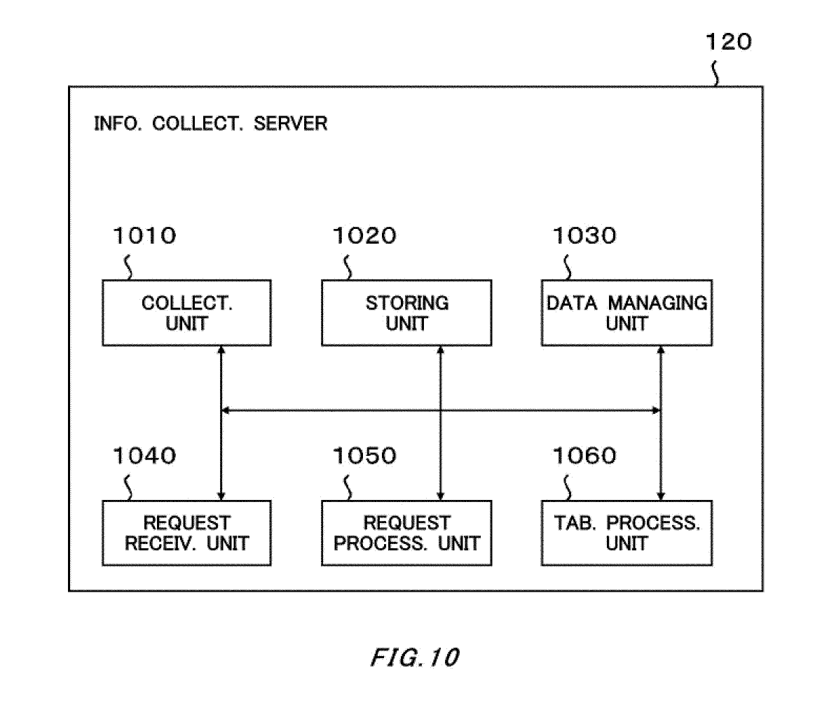

FIG. 10 schematically shows one example of the information collecting server 120. In the present embodiment, the information collecting server 120 includes a collecting unit 1010, a storing unit 1020, a data managing unit 1030, a request receiving unit 1040, a request processing unit 1050 and a tabulation processing unit 1060. The request receiving unit 1040 may be one example of a region information acquiring unit. The request processing unit 1050 may be one example of a tabulation data transmitting unit and a sample data transmitting unit.

In the present embodiment, the collecting unit 1010 collects a plurality of pieces of log information from one or more communication terminals 110. The storing unit 1020 stores a plurality of pieces of log information collected by the collecting unit 1010. The data managing unit 1030 manages the plurality of pieces of log information stored in the storing unit 1020. For example, the data managing unit 1030 compares the plurality of pieces of log information to delete log information corresponding to an outlier. If a difference between positional information of a plurality of pieces of log information that are temporally continuous is smaller than a predetermined value, and communication environment information of the plurality of pieces of log information is the same or a difference therebetween is smaller than a predetermined value, the data managing unit 1030 may delete part of the plurality of pieces of log information. Thereby, data amount can be reduced. The data managing unit 1030 may generate one piece of log information representative of the above-mentioned plurality of pieces of log information.

The request receiving unit 1040 acquires region information indicating a tabulation process target coordinate region from the client terminal 130. The request receiving unit 1040 transmits the received region information to the request processing unit 1050. The region information may include region specifying information for specifying a coordinate region on a coordinate plane expressed by a first coordinate axis and a second coordinate axis. The region information may include unit specifying information for specifying a range of coordinates included in a unit region virtually dividing a coordinate plane. The unit specifying information may include information indicating the scale of a map or information indicating that the scale is to be altered.

More specifically, in the present embodiment, the request receiving unit 1040 receives a tabulation request signal from the client terminal 130. The request receiving unit 1040 transmits the received tabulation request signal to the request processing unit 1050. The tabulation request signal includes information for specifying a tabulation process target geographic range (which may be sometimes referred to as an area). The above-mentioned information for specifying an area may be positional information indicating a range of the above-mentioned area or may be area identifying information identifying the above-mentioned area.

The area identifying information may include information indicating the scale of a map or information indicating that the scale is to be altered. Thereby, the request processing unit 1050 can specify a range of an area included in a grid square virtually dividing a map. For example, it can specify whether each grid square corresponds to a 100-m square area or corresponds to a 1-km square area. With the area identifying information including information indicating that the scale is to be altered, the request processing unit 1050 can specify the scale after the alteration.

The area identifying information may include image identifying information identifying a map image of a tabulation process target area at a particular scale. Thereby, the tabulation process target area can be specified. Much of map information is prepared in a fixed pixel scheme. More specifically, map information includes a set of a plurality of tile images making up an entire map image for each scale level, for example. In each tile image, the pixel count in the longitude direction (which is the x-direction. for example) and the pixel count in the latitude direction (which is the y-direction, for example) are fixed. Also, unique identifying information is allocated to each tile image. Thereby, any map image can be generated by designating a scale level and identifying information allocated to a tile image.

As a response to a tabulation request signal, the request processing unit 1050 transmits, to the client terminal 130, at least one of log information included in a tabulation process target area (or part of the log information) and a tabulated value of the log information. The request processing unit 1050 may determine whether or not each piece of log information is included in a tabulation process target area based on the positional information of each piece of log information.

(I) If at least one of region information included in a tabulation request signal, the load on the information collecting server 120 and the load on the communication network 10 satisfies a predetermined condition, the request processing unit 1050 for example transmits a tabulation process condition to the tabulation processing unit 1060, and requests to tabulate log information included in an area indicated by the tabulation request signal among a plurality of pieces of log information stored in the storing unit 1020. The request processing unit 1050 receives the tabulation result from the tabulation processing unit 1060, and transmits the tabulation result to the client terminal 130.

On the one hand, (II) if at least one of region information included in a tabulation request signal, the load on the information collecting server 120 and the load on the communication network 10 does not satisfy a predetermined condition, the request processing unit 1050 transmits part of or entire log information included in an area indicated by the tabulation request signal to the client terminal 130. For example, the request processing unit 1050 associates, with each other, the positional information of each piece of log information and a tabulation target parameter, and transmit them to the client terminal 130.

The above-mentioned predetermined condition may be (a) a condition that the scale specified by information indicating the scale of a map or information indicating that the scale is to be altered is equal to a predetermined scale or smaller than the predetermined scale. The predetermined scale may be decided based on at least one of the number of tabulation target parameters, the type of the parameters and the data type of the parameters. Examples of the data type of the tabulation target parameters may include quantitative data, qualitative data, non-numeric data and the like.

If for example, there is one type of the above-mentioned parameters, it is “Communication Possibility,” and the number of pieces of log information corresponding to each among three classes of “Communication Possibility” is to be tabulated, the above-mentioned predetermined scale is set as a first value. On the one hand, if there are two types of the above-mentioned parameters, they are “Class of Communication Carrier” and “Communication Possibility,” and the number of pieces of log information corresponding to each among three classes of “Communication Possibility” for each “Class of Communication Carrier” is to be tabulated, the above-mentioned predetermined scale is set as a second value.

In one embodiment, the second value may be larger than the first value. In this case, if the load of a tabulation process is large, the tabulation process is implemented on the information collecting server 120 side even if the scale is large as compared with that in a case where the load of the tabulation process is small. Thereby, the load on the client terminal 130 side can be mitigated.

In another embodiment, the second value may be smaller than the first value. In this case, if the load of a tabulation process is large, the tabulation process is not implemented on the information collecting server 120 side even if the scale is small as compared with that in a case where the load of the tabulation process is small. Thereby, the load on the information collecting server 120 side can be mitigated.

The above-mentioned predetermined condition may be (b) a condition that the number of pieces of log information included in a tabulation process target area is equal to a predetermined value or smaller than the predetermined value. The predetermined value may be decided based on at least one of the number of tabulation target parameters, the type of the parameters and the data type of the parameters.

The above-mentioned predetermined condition may be (c) a condition that the size of a tabulation process target area is equal to a predetermined value or smaller than the predetermined value. The predetermined value may be decided based on at least one of the number of tabulation target parameters, the type of the parameters and the data type of the parameters.

The above-mentioned predetermined condition may be (d) a condition that at least one of the load on the information collecting server 120 and the load on the communication network 10 is equal to a predetermined value or larger than the predetermined value. The predetermined value may be decided based on at least one of the number of tabulation target parameters, the type of the parameters and the data type of the parameters. Whether or not the above-mentioned predetermined condition is satisfied may be decided based on latency of the information collecting server 120, the utilization status of resources of the information collecting server 120 or the like.

In the present embodiment, the tabulation processing unit 1060 implements a tabulation process based on a request from the request processing unit 1050. The tabulation processing unit 1060 receives a tabulation process condition from the request processing unit 1050. The tabulation processing unit 1060 tabulates log information included in an area indicated by a tabulation request signal among a plurality of pieces of log information stored in the storing unit 1020. For example, for each among one or more classes about a tabulation target parameter, the tabulation processing unit 1060 calculates a tabulated value of log information corresponding to each class. The tabulation processing unit 1060 may calculate a tabulated value for each grid square. The request processing unit 1050 may decide the size of a grid square based on information indicating the scale of a map or information indicating that the scale is to be altered.

In one embodiment, the tabulation process in the tabulation processing unit 1060 includes: a procedure of extracting log information included in a tabulation process target area for each grid square based on positional information of each among a plurality of pieces of log information; a procedure of associating the extracted log information with any one of one or more classes about a tabulation target parameter of the extracted log information based on details of the parameter; and a procedure of tabulating the number of pieces of log information corresponding to each among one or more classes for each grid square. In this case, the tabulation process is implemented after a tabulation request signal is received. Thereby, a tabulation result based on newer data can be output.

In another embodiment, for each parameter of log information for each grid square of a second size, the tabulation processing unit 1060 calculates a tabulated value of log information corresponding to each among one or more classes about the parameter regularly for example, and stores the tabulated value in the storing unit 1020. In response to a request from the request processing unit 1050 instructing to tabulate log information for each grid square of a first size, for each among grid squares of the first size included in a tabulation target area, the tabulation processing unit 1060 first judges whether or not a grid square of the second size the tabulated value of which has already been calculated is included.

If a grid square of the first size includes a grid square of the second size, the tabulation processing unit 1060 utilizes a tabulation result of each among grid squares of the second size to tabulate the number of pieces of log information corresponding to each among one or more classes about a tabulation target parameter in the grid square of the first size. If a grid square of the first size does not include a grid square of the second size, the tabulation processing unit 1060 extracts log information included in the grid square of the first size. Also, based on details of a tabulation target parameter of the extracted log information, it tabulates the number of pieces of log information corresponding to each among one or more classes about the parameter. Thereby, the tabulation time can be shortened.

The tabulation processing unit 1060 may utilize log information collected after last implementation of a tabulation process of grid squares of the second size, and a tabulation result of each among grid squares of the second size to tabulate log information. Thereby, a tabulation result based on newer data can be output.

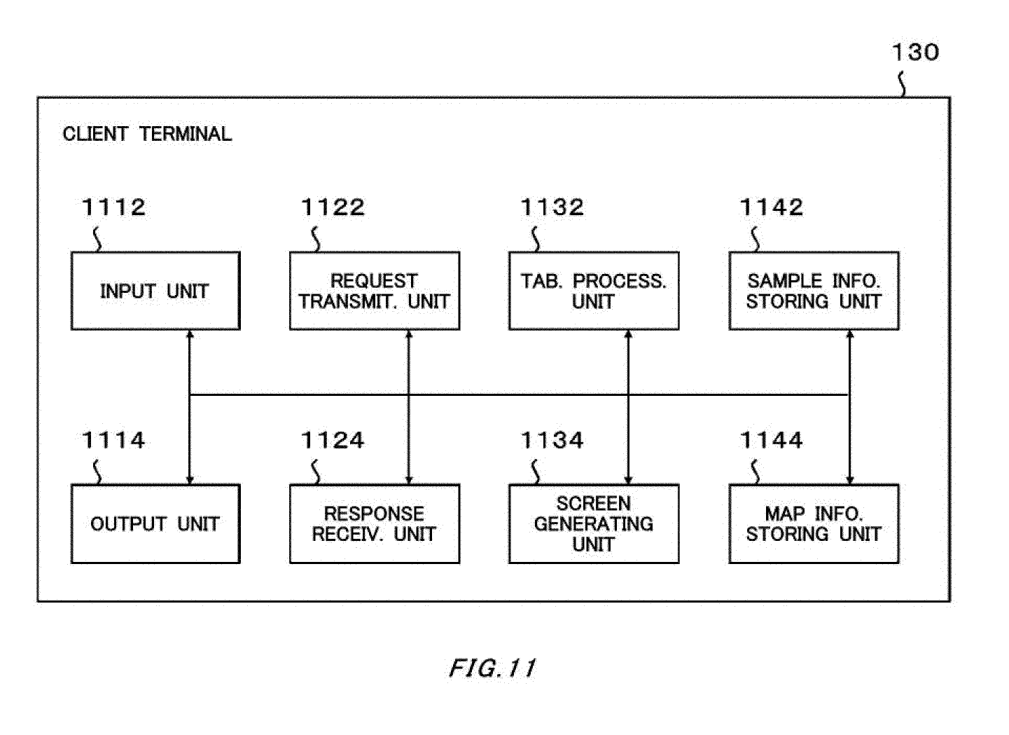

FIG. 11 schematically shows one example of the client terminal 130. In the present embodiment, the client terminal 130 includes an input unit 1112, an output unit 1114, a request transmitting unit 1122, a response receiving unit 1124, a tabulation processing unit 1132, a screen generating unit 1134, a sample information storing unit 1142 and a map information storing unit 1144. The tabulation processing unit 1132 may be one example of a tabulating unit.

Each of the input unit 1112 and the output unit 1114 may have a configuration similar to those of the input unit 212 and the output unit 222. The sample information storing unit 1142 stores part of or entire log information included in a response from the information collecting server 120. The map information storing unit 1144 stores map information.

The request transmitting unit 1122 transmits a tabulation request signal to the information collecting server 120 to request log information included in a tabulation process target area or a tabulated value of the log information. The response receiving unit 1124 receives a response to the tabulation request signal from the information collecting server 120. In the present embodiment, if the response to the tabulation request signal includes a tabulated value, the response receiving unit 1124 transmits the tabulated value to the screen generating unit 1134. The response receiving unit 1124 may store the tabulated value in the sample information storing unit 1142.

In the present embodiment, if the response to the tabulation request signal does not include a tabulated value, but includes part of or entire log information included in a tabulation process target area, the response receiving unit 1124 stores the part of or entire of the log information in the sample information storing unit 1142. Also, it requests the tabulation processing unit 1132 to implement a tabulation process on the part of or entire log information.

In the present embodiment, in response to the request from the response receiving unit 1124, the tabulation processing unit 1132 tabulates log information received from the information collecting server 120. The tabulation processing unit 1132 may have a configuration similar to that of the tabulation processing unit 1060, and tabulate the above-mentioned log information by a procedure similar to that of the tabulation processing unit 1060. For example, for each among one or more classes about a tabulation target parameter, the tabulation processing unit 1132 calculates a tabulated value of log information corresponding to each class. The tabulation processing unit 1132 may calculate a tabulated value for each grid square. The tabulation processing unit 1132 transmits a tabulation result to the screen generating unit 1134.

The screen generating unit 1134 generates a screen for outputting the tabulation result. In one embodiment, the screen generating unit 1134 generates a screen on which a chart indicating a tabulation result in each grid square is displayed at a position representative of each grid square on a map. Examples of the chart may include a cumulative bar chart, a pie chart, a doughnut chart, an area chart, a radar chart and the like. Thereby, a user can analyze data intuitively.

In another embodiment, the screen generating unit 1134 generates a screen on which a chart indicating a tabulation result in each grid square is displayed at a position decided by a greedy method. Thereby, the chart icons 604 can be arranged along a road, railroad or the like on a map. Also, a user can more intuitively grasp a region to be analyzed in detail.

In another embodiment, if at least one of region information and a user instruction satisfies a predetermined condition, the screen generating unit 1134 generates a screen on which an icon or symbol corresponding to details of a tabulation target parameter of each piece of log information is displayed at a position on a map corresponding to positional information of each among one or more pieces of log information included in at least one grid square. Thereby, a user can switch between a display of a tabulation result by the chart icon 914 and a display of raw data by the sample icon 924 by a simple manipulation.

While the embodiments of the present invention have been described, the technical scope of the invention is not limited to the above described embodiments. It is apparent to persons skilled in the art that various alterations and improvements can be added to the above-described embodiments. Also, matters explained about a particular embodiment can be applied to another embodiment, unless such an application causes technical contradictions. It is also apparent from the scope of the claims that the embodiments added with such alterations or improvements can be included in the technical scope of the invention.

The operations, procedures, steps, and stages of each process implemented by an apparatus, system, program, and method shown in the claims, embodiments, or diagrams can be implemented in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be implemented in this order.

### EXPLANATION OF REFERENCE SYMBOLS

10: communication network; 20: information providing server; 100: communication status analyzing system; 110: communication terminal; 120: information collecting server; 130: client terminal; 212: input unit; 214: process executing unit; 216: environment information acquiring unit; 218: positional information acquiring unit; 222: output unit; 224: identifying information acquiring unit; 226: log information generating unit; 228: communication control unit; 300: data table; 310: terminal ID; 320: date and time; 330: positional information; 340: GPS accuracy; 350: communication environment information; 352: communication possibility; 354: throughput; 356: latency; 400: screen; 402: map image; 404: chart icon; 510: grid square; 600: screen; 602: map image; 604: chart icon; 710: grid square; 800: screen; 802: map image; 804: sample icon; 806: sample icon; 910: screen; 914: chart icon; 920: screen; 924: sample icon; 1010: collecting unit; 1020: storing unit; 1030: data managing unit; 1040: request receiving unit; 1050: request processing unit; 1060: tabulation processing unit; 1112: input unit; 1114: output unit; 1122: request transmitting unit; 1124: response receiving unit; 1132: tabulation processing unit; 1134: screen generating unit; 1142: sample information storing unit; 1144: map information storing unit

What is claimed is:

1. A non-transitory computer-readable medium that stores a program, wherein the program causes a computer to execute:
a procedure of acquiring, from a client terminal, region information indicating a coordinate region;
a procedure of implementing a statistical process on a piece of sample data included in the coordinate region from among a plurality of pieces of sample data in which coordinate positions and information related to the coordinate positions are associated with each other, and transmitting the piece of sample data to the client terminal if at least one of: the region information; a load on the computer; and a load on a communication line between the computer and the client terminal satisfies a predetermined condition; and
a procedure of transmitting, to the client terminal, the piece of sample data included in the coordinate region if at least one of: the region information; the load on the computer; and the load on the communication line does not satisfy the predetermined condition.

2. The non-transitory computer-readable medium according to claim 1, wherein
the region information includes:
region specifying information for specifying the coordinate region on a coordinate plane expressed by a first coordinate axis and a second coordinate axis; and
unit specifying information for specifying a range of coordinates included in a first unit region that virtually divides the coordinate plane.

3. The non-transitory computer-readable medium according to claim 2, wherein
the procedure of implementing a statistical process on the piece of sample data included in the coordinate region and transmitting the piece of sample data to the client terminal has:
a procedure of extracting, for each first unit region, the piece of sample data included in the coordinate region specified by the region specifying information based on a coordinate position of each among the plurality of pieces of sample data;
a procedure of associating an extracted piece of sample data with any one of one or more classes about the information related to the coordinate position based on the information related to the coordinate position of the extracted piece of sample data; and
a procedure of tabulating, for each first unit region, a number of pieces of sample data corresponding to each among the one or more classes.

4. The non-transitory computer-readable medium according to claim 2, wherein
the procedure of implementing a statistical process on the piece of sample data included in the coordinate region and transmitting the piece of sample data to the client terminal has:
a procedure of referring to a storing means storing a tabulated value of sample data corresponding to each among one or more classes about the information related to the coordinate position for each second unit region that virtually divides the coordinate plane, and tabulating, for each first unit region, a number of pieces of sample data corresponding to each among the one or more classes based on the tabulated value corresponding to each among the one or more classes in the second unit region included in the first unit region.

5. The non-transitory computer-readable medium according to claim 2, wherein the unit specifying information includes information indicating a scale of a map or information indicating that the scale is to be altered.

6. The non-transitory computer-readable medium according to claim 1, wherein the coordinate position includes positional information indicating a geographic position at which the information related to the coordinate position is acquired.

7. A non-transitory computer-readable medium that stores a program, wherein the program causes a computer of a client terminal to execute:
a procedure of transmitting, to a server, region information indicating a coordinate region, and requesting: a piece of sample data included in the coordinate region from among a plurality of pieces of sample data in which coordinate positions and information related to the coordinate positions are associated with each other; or statistics of the piece of sample data included in the coordinate region; and
a procedure of calculating statistics of sample data corresponding to each among one or more classes about the information related to the coordinate position for each unit region that virtually divides the coordinate region on a coordinate plane expressed by a first coordinate axis and a second coordinate axis if a response to the request does not include the statistics of the piece of sample data included in the coordinate region but includes the piece of sample data included in the coordinate region.

8. The non-transitory computer-readable medium according to claim 7, wherein the program causes the computer to execute further a procedure of generating a screen on which a chart indicating statistics in each unit region is displayed at a position representative of each unit region on the coordinate plane.

9. The non-transitory computer-readable medium according to claim 7, wherein the program causes the computer to execute further a procedure of generating a screen on which an icon or symbol corresponding to the information related to the coordinate position of each piece of sample data included in at least one unit region is displayed at a position on the coordinate plane corresponding to a coordinate position of each piece of sample data included in the at least one unit region if at least one of the region information and a user instruction satisfies a predetermined condition.

10. A statistical processing system comprising:
a region information acquiring unit that acquires, from a client terminal, region information indicating a coordinate region;
a statistical data transmitting unit that implements a statistical process on a piece of sample data included in the coordinate region from among a plurality of pieces of sample data in which coordinate positions and information related to the coordinate positions are associated with each other, and transmits the piece of sample data to the client terminal if at least one of: the region information; a load on the statistical processing system; and a load on a communication line between the statistical processing system and the client terminal satisfies a predetermined condition; and
a sample data transmitting unit that transmits, to the client terminal, the piece of sample data included in the coordinate region if at least one of: the region information; the load on the statistical processing system; and the load on the communication line does not satisfy the predetermined condition.

11. The statistical processing system according to claim 10, further comprising the client terminal, wherein
the client terminal has:
a request transmitting unit that transmits, to a server, region information indicating a coordinate region, and requests: a piece of sample data included in the coordinate region from among a plurality of pieces of sample data in which coordinate positions and information related to the coordinate positions are associated with each other; or statistics of the piece of sample data included in the coordinate region; and
a statistical processing unit that calculates statistics of sample data corresponding to each among one or more classes about the information related to the coordinate position for each unit region that virtually divides the coordinate region on a coordinate plane expressed by a first coordinate axis and a second coordinate axis if a response to the request does not include the statistics of the piece of sample data included in the coordinate region but includes the piece of sample data included in the coordinate region.

12. The statistical processing system according to claim 11, further comprising a screen generating unit that generates a screen on which a chart indicating statistics in each unit region is displayed at a position representative of each unit region on the coordinate plane.

13. The statistical processing system according to claim 11, further comprising a screen generating unit that generates a screen on which an icon or symbol corresponding to the information related to the coordinate position of each piece of sample data included in at least one unit region is displayed at a position on the coordinate plane corresponding to a coordinate position of each piece of sample data included in the at least one unit region if at least one of the region information and a user instruction satisfies a predetermined condition.

14. The statistical processing system according to claim 10, wherein
the region information includes:
region specifying information for specifying the coordinate region on a coordinate plane expressed by a first coordinate axis and a second coordinate axis; and
unit specifying information for specifying a range of coordinates included in a first unit region that virtually divides the coordinate plane.

15. The statistical processing system according to claim 14, wherein
the statistical data transmitting unit:
extracts, for each first unit region, the piece of sample data included in the coordinate region specified by the region specifying information based on a coordinate position of each among the plurality of pieces of sample data;
associates an extracted piece of sample data with any one of one or more classes about the information related to the coordinate position based on the information related to the coordinate position of the extracted piece of sample data; and
tabulates, for each first unit region, a number of pieces of sample data corresponding to each among the one or more classes.

16. The statistical processing system according to claim 14, wherein
the statistical data transmitting unit refers to a storing means storing a tabulated value of sample data corresponding to each among one or more classes about the information related to the coordinate position for each second unit region that virtually divides the coordinate plane, and tabulates, for each first unit region, a number of pieces of sample data corresponding to each among the one or more classes based on the tabulated value corresponding to each among the one or more classes in the second unit region included in the first unit region.

17. The statistical processing system according to claim 14, wherein the unit specifying information includes information indicating a scale of a map or information indicating that the scale is to be altered.

18. The statistical processing system according to claim 10, wherein the coordinate position includes positional information indicating a geographic position at which the information related to the coordinate position is acquired.
